(19) United States
(12) Patent Application Publication
(10) Pub. No.: US 2007/0289477 A1
(43) Pub. Date: Dec. 20, 2007

(54) Railway Track For Vehicles With Various Means Of Locomotion And Drive Systems, And Vehicle For Travelling On Said Railway Track

(76) Inventor: Walter Sobolewski, Hamburg (DE)

Correspondence Address: BORDEN LADNER GERVAIS LLP;Gail C. Silver, 1100-100 QUEEN ST, OTTAWA, ON, K1P 1J9, CA

(21) Appl. No.: 10/598,959

(22) PCT Filed: Mar. 18, 2005
(86) PCT No.: PCT/DE05/00514

§ 371 Date: Jul. 10, 2007

(30) Foreign Application Priority Data
Mar. 18, 2004 (DE) 102004014413.3

(51) Int. Cl. E01B 25/28; B60F 1/02; E01B 25/30

(52) U.S. Cl. 105/215.2; 104/130.11; 104/281; 238/130; 238/148; 295/1

(57) ABSTRACT

The invention relates to a railway track for vehicles with various means of locomotion and drive systems, enabling transitions from one type of roadway to another type of roadway to be carried out smoothly. The invention also relates to vehicle that is adapted to said railway track in an optimum manner and, if necessary, can travel without the railway track. The inventive railway track (2) consists of two parallel rails (7) provided with one or two wing-type extension arms (9), enabling vehicles to travel on the track with a flange wheel (5) as well as a road wheel (4), and with magnetic levitation (6). The vehicle (1) traveling on the railway track (2) can thus be embodied as a road, rail, or magnetic levitation vehicle and can also combine a plurality of means of locomotion and drive systems

### FIELD OF THE INVENTION

The present invention relates to a railway track, which may be traveled by vehicles, such as motor vehicles, rail vehicles, and/or magnetic levitation vehicles having various means of locomotion and drive systems, such as a road wheels, flange wheels, and magnetic levitation technology.

### BACKGROUND OF THE INVENTION

A multipurpose vehicle for using individual different and independent roadways is known from DE 101 25 617 A1 and DE 101 60 247 A1.

This vehicle is alternatively designed for three types of locomotion such as wheel-road, wheel-rail, and magnetic levitation technology. It has a combined flange wheel and road wheel for the wheel-road and wheel-rail types of locomotion. For use as a magnetic levitation vehicle, at least four supports having current-carrying magnetic coils which may be extended and/or pivoted out are situated on both sides on the chassis and asynchronous short-stator motors are situated on the sides.

For the transition from one type of locomotion to the other, ramps are used, at which the roadways may be lowered in relation to one another. To overcome uneven points, such as intersections, branches, and road transitions, parts of the roadways are also lowered or folded down in relation to one another.

The disadvantage of this system is that the vehicle is not optimally adapted to a magnetic levitation route and, in addition, this route may not be traveled by typical vehicles which are equipped with a drive system.

Furthermore, the same route may also not be alternatively traveled by vehicles of the types of locomotion cited.

It is thus generally known that motor vehicles having road wheels travel at ground-level on roads, or freeways, and other paths. However, it is not known that motor vehicles having road wheels may travel on a railway track without additional aid.

Furthermore, it is known that magnetic levitation vehicles are equipped with two-part magnetic levitation technology, such as the Transrapid, and travel on a magnetic levitation route. However, it is not known that motor vehicles or magnetic levitation trains having two-part or four-part magnetic levitation technology may travel on a railway track.

### SUMMARY OF THE INVENTION

It is the object of the present invention to provide a railway track for vehicles having various means of locomotion and drive systems, on which smooth transitions among roadways are possible using the same vehicle. The multiple usage of a railway track is to increase transport performance and protect the environment and resources. Moreover, a vehicle is to be provided, which is adapted in the most optimal way to this railway track and, if necessary, also manages without this railway track.

The object is achieved by the features according to the present invention of claim 1. Advantageous refinements and embodiments are the subject matter of the subclaims.

The railway track comprises two rails, which are designed so that they may be traveled by vehicles having various means of locomotion and drive systems, the means of locomotion being able to be a road wheel, flange wheel, and/or an electromagnetic field. Every means of locomotion may be situated on the vehicle alone or in combination with another means of locomotion for traveling the railway track. The rails of the railway track have one or two wing-like extension arms for this purpose, which alternatively permit, in addition to travel using a road wheel, travel using a flange wheel and using magnetic levitation technology.

A winged rail of the railway track implemented in this way preferably comprises a stable double-T profile having a perpendicular traverse, a rail head arching up in the middle along the rail, supported by the traverse.

A winged railway track having a trimodal design of this type may be used for road, railway, and magnetic levitation vehicles. The necessity of constructing three different roadways is thus dispensed with in many cases, namely,
one for motor vehicles,
one for railway vehicles,
one for magnetic levitation vehicles, as has been practiced until now.

Thus, a motor vehicle having road wheels, flange wheels, or magnetic levitation technology, a railway vehicle having flange wheels, and a magnetic levitation vehicle having two-part or four-part drive may travel on the same railway track.

Using the new achievement of the object, significantly less land is constructed on and investment costs are saved.

Through the use of magnetic levitation technology in all vehicle species and adaptation of the travel velocities to one another, a multiple performance increase is achieved when using the winged railway track.

The use of magnetic levitation technology on the trimodal roadway according to the present invention, which may be erected on the rail network and/or on the freeway, results in halving of the travel and freight times and is highly advantageous for the national economy.

Since magnetic levitation routes have been implemented until now only for experimental purposes, these may be implemented at low outlay in connection with the existing routes and designed beforehand for trimodal use.

The new winged railway track thus offers multiple advantages and applications. It may thus be used by a vehicle having a trimodal drive systems, which is advantageous, for example, if one of the drive systems, such as the levitation technology, breaks down or the vehicle wishes to leave this route in order to be able to come closer to urban centers, for example.

For example, utility motor vehicles may be equipped with magnetic levitation technology, which are assembled to form trains which travel the winged railway track.

In addition, vehicles which either have only road wheels or only rail wheels may travel on the new route according to the present invention, which may be necessary for repair or detour trips, for example.

### BRIEF DESCRIPTION OF THE DRAWINGS

Several exemplary embodiments of the achievement of the object according to the present invention will be described in greater detail on the basis of the drawings.

FIG. 1 shows a schematic illustration of the winged railway track having a motor vehicle, which is driven to travel on the winged railway track using a road wheel,

FIG. 2 shows a schematic illustration of the winged railway track having a motor vehicle, which is driven using a flange wheel on the winged railway track,

FIG. 3 shows a schematic illustration of the winged railway track having a motor vehicle which is driven using a two-part or four-part magnetic levitation technology on the winged railway track,

FIG. 4 shows a schematic illustration of the winged railway track having a rail vehicle which is driven using a flange wheel on the winged railway track,

FIG. 5 shows a schematic illustration of the winged railway track having a magnetic levitation vehicle which is driven using a two-part or four-part magnetic levitation technology on the winged railway track,

FIG. 6 shows an embodiment of a switch for use with the trimodal vehicle drive system on the winged railway track.

### DETAILED DESCRIPTION

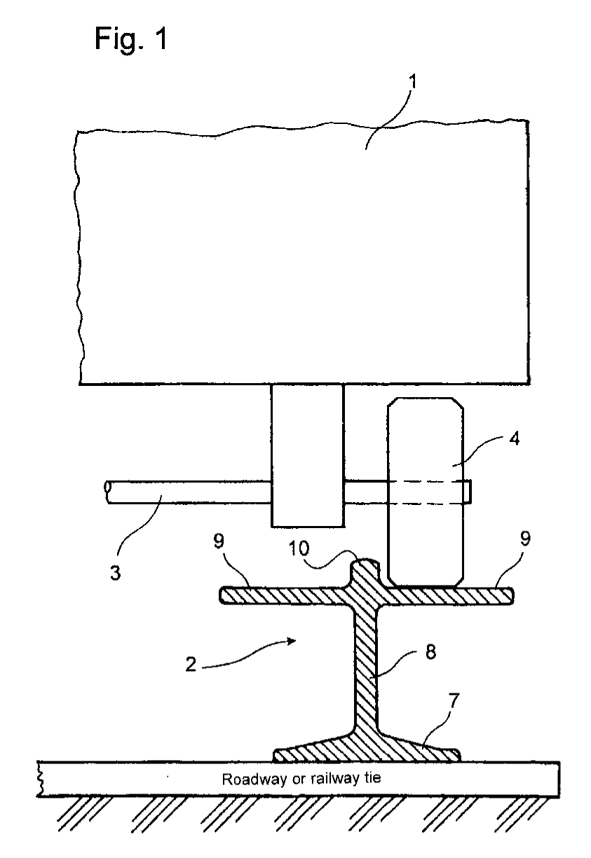

FIG. 1 shows a schematic illustration of a motor vehicle 1, which travels on a winged railway track 2 driven by a road wheel 4. The winged railway track 2 is equipped for alternative travel using three different travel systems.

To simplify the drawing, only one side of the vehicle 1 having a wheel 4 on an axle 3 is illustrated on a rail 7 of the winged railway track 2.

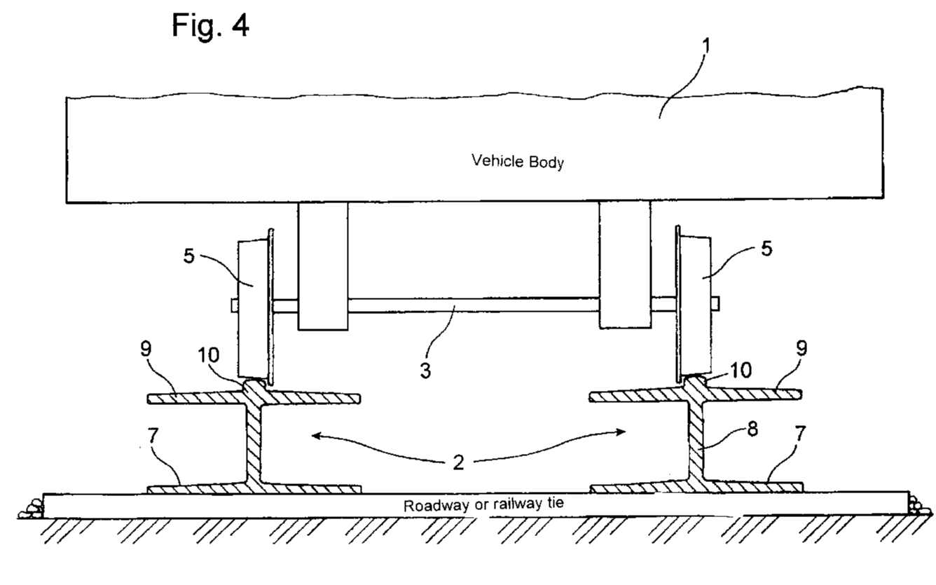

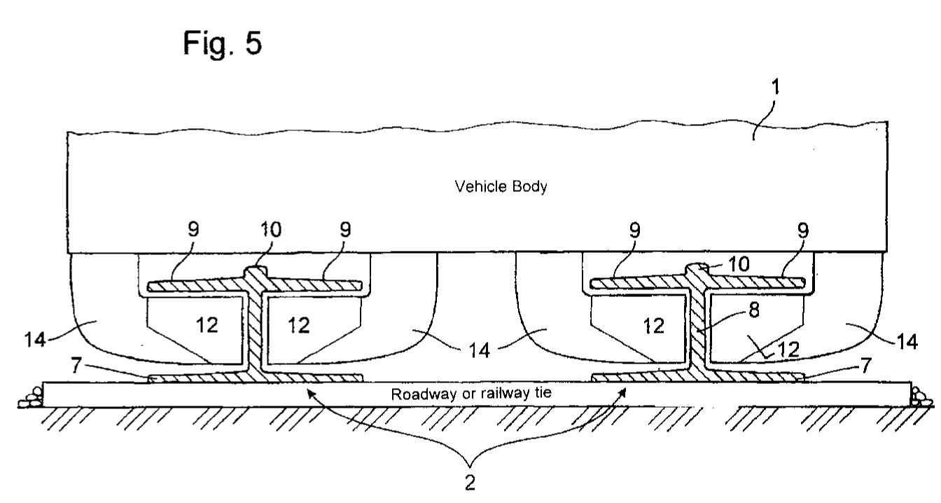

The rail 7 is implemented in the form of a stable double-T profile having a perpendicular traverse 8. The upper T-shape of the rail 7 has sufficient width so that the surface 9 thus formed, as shown in FIG. 1, may be traveled using the road wheel 4, but also using a rail vehicle (FIG. 4) or a magnetic levitation vehicle (FIG. 5).

A rail head 10 is arched in the middle of the surface 9 along the rail 7, which is supported by the traverse 8.

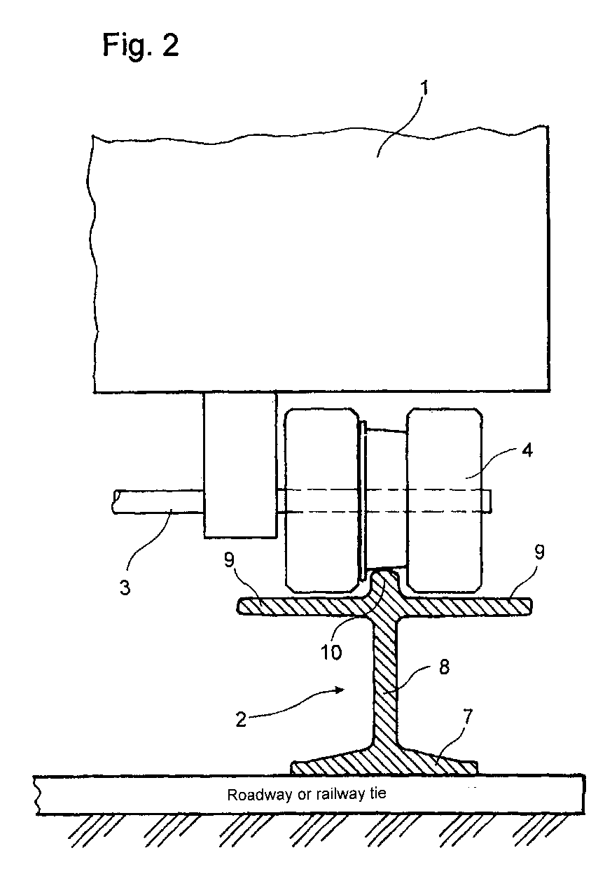

FIG. 2 shows a motor vehicle 1 which is driven using a flange wheel 5 and travels using its flange wheel 5 on the rail head 10.

The road wheel 4 is implemented having twin tires, the flange wheel 5 being situated between the two twin tires 4. The upper T-shape of the rail 7 is implemented as sufficiently wide so that the surface 9 thus formed may be traveled using the road wheels 4 and, in addition, the rail head 10 may be traveled using the flange wheel 5. In this embodiment, the vehicle 1 may travel further on a normal road.

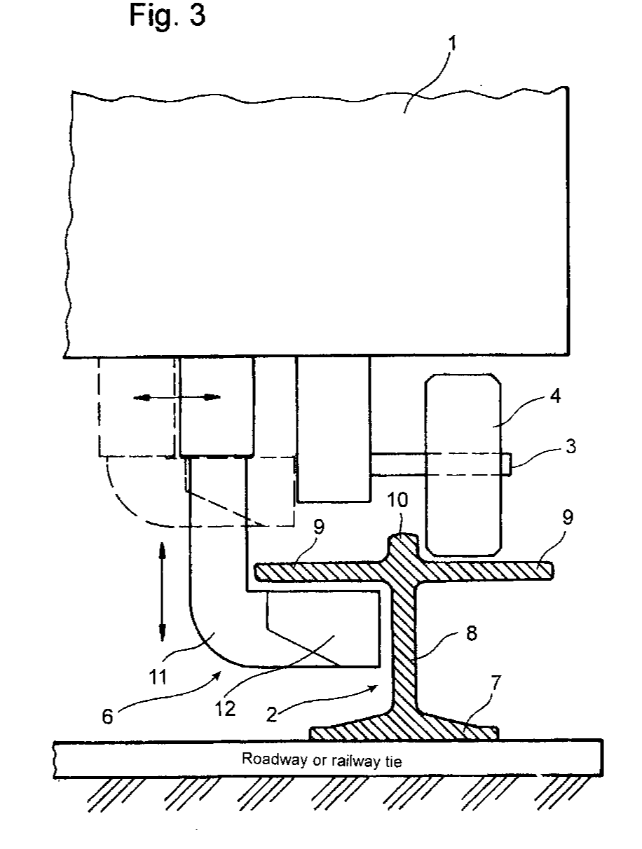

FIG. 3 shows a motor vehicle 1 on which additional magnetic levitation technology 6 is situated for locomotion as a magnetic levitation vehicle on the winged railway track 2. The magnetic levitation technology 6 is implemented as a pivotable arm 11 and is used as a holder for a support electromagnet, a guide magnet, and an asynchronous short-stator motor 12, which builds up an electromagnetic traveling wave field in relation to the rail 7. The support arms 11 are situated so they are retractable, in order that the vehicle 1 may also travel using the road wheel 4.

FIG. 4 shows a vehicle 1 which exclusively travels as a rail vehicle using flange wheels 5 on the winged railway track 2.

Finally, as FIG. 5 shows, it is also possible and expedient for high velocities for the vehicle 1 to travel purely as a magnetic levitation vehicle using magnetic levitation technology 6 on the winged railway track 2.

For this purpose, the magnetic levitation technology 6 engages under the wing surfaces 9 of the rail 7 using its support arms 14. Support electromagnets, guide magnets, and asynchronous short-stator motors 12 are situated on the support arms 14 of the vehicle 1 for the locomotion as a magnetic levitation vehicle.

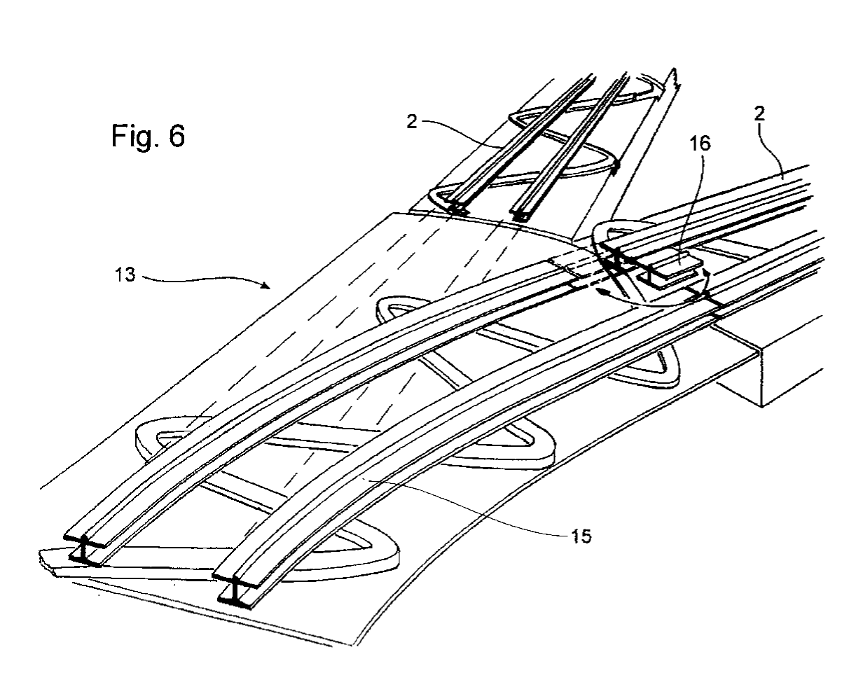

FIG. 6 shows a switch 13 for the winged railway track 2. It comprises flexible rail parts 15, which are situated on a circular path so they are pivotable in pairs. In addition, a retractable rail part 16 is situated so it is foldable for the required length equalization of one of the rail parts. As an alternative to the flexible rails, the pivotable rail parts 15 may also comprise elements arrayed in a formfitting way and rotatable in relation to one another.

### LIST OF REFERENCE NUMERALS

| | |
|---|---|
| vehicle | 1 |
| winged railway track | 2 |
| vehicle axle | 3 |
| road wheel | 4 |
| flange wheel | 5 |
| magnetic levitation technology | 6 |
| rail | 7 |
| traverse | 8 |
| upper surface of the rail | 9 |
| rail head | 10 |
| extendable support arm | 11 |
| support electromagnet, guide magnet, and | 12 |
| asynchronous short-stator motor | |
| switch | 13 |
| support arm | 14 |
| pivotable rail parts | 15 |
| retractable rail piece | 16 |

What is claimed is:

1. A railway track, for vehicles having various means of locomotion and drive systems, comprising two rails that run parallel to one another, wherein one or two wing-like extension arms * are situated on each rail of the railway track, which permit travel using a road wheel, travel using a flange wheel, and travel using magnetic levitation technology.

2. The railway track according to claim 1, wherein the rail comprises a stable double-T profile having a perpendicular traverse, wherein the upper T-profile forms the wing-like extension arms, and wherein a rail head supported by the traverse, is arched on top in the middle along the rail.

3. The railway track according to claims 1, wherein a switch, which comprises flexible rail parts pivotable in pairs on a circular path, is situated at branches of the railway track, and a retractable rail piece is disposed on one of the rail parts in a foldable manner to equalize the length of said rail parts.

4. The railway track according to claim 3, wherein the pivotable rail parts comprise elements arrayed in a formfitting way and rotatable in relation to one another.

5. A vehicle for use as a road, rail or magnetic levitation vehicle for traveling the railway track of claim 1, wherein flange wheels, which roll on the rail head of the rails, are situated below, on the chassis of the vehicle for the alternative use as a rail vehicle.

6. A vehicle for use as a road, rail or magnetic levitation vehicle, for traveling the railway track according to claim 1, wherein, for the alternative use as a road or rail vehicle, the flange wheel is attached on the same axle as the road wheel, the flange wheel having a smaller diameter than the road wheel.

7. A vehicle for use as a road, rail or magnetic levitation vehicle for traveling the railway track according to claim 6, wherein the road wheel on the vehicle axle is connected via a cranked axle to the flange wheel and, by rotating the axle by 180°, either the flange wheel is seated on the rail head or the road wheel is seated on the extension arm of the rail.

8. A vehicle for use as a road, rail or magnetic levitation vehicle for traveling the railway track according to claim 6, wherein the road wheel is twin tires and the flange wheel is situated between the two twin tires.

9. A vehicle for use as a road, rail or magnetic levitation vehicle, for traveling the railway track according to claim 1, wherein for the alternative use as a magnetic levitation vehicle, support arms having magnetic coils and drive units for magnetic levitation, which engage below the wing-like extension arms of the rail, are situated below, on the chassis of the vehicle.

10. A vehicle for use as a road, rail or magnetic levitation vehicle, for traveling the railway track according to claim 9, wherein the support arms for magnetic levitation, which engage below the extension arms on the rail, are situated in two or four parts on the vehicle.

11. A vehicle for use as a road, rail or magnetic levitation vehicle, for traveling the railway track according to claim 9, wherein the support arms below the vehicle are extendable and, when not used as a magnetic levitation vehicle, are retracted into the vehicle.

12. A vehicle for use as a road, rail or magnetic levitation vehicle, for traveling the railway track according to claim 1, wherein a synchronization unit is situated in the vehicle to provide the flange wheel with a rotational velocity which is adapted to the traveling velocity of the vehicle before touchdown of the vehicle from the levitating state.
